(19) United States
(12) Patent Application Publication
(10) Pub. No.: US 2018/0278987 A1
(43) Pub. Date: Sep. 27, 2018

(54) SYSTEM FOR ADVERTISING USING PVR AND METHOD OF USE

(71) Applicant: Loreto J. Ceccarelli, Vaughan (CA)

(72) Inventor: Loreto J. Ceccarelli, Vaughan (CA)

(21) Appl. No.: 15/934,035

(22) Filed: Mar. 23, 2018

Related U.S. Application Data
(60) Provisional application No. 62/475,543, filed on Mar. 23, 2017.

(51) Int. Cl. H04N 21/431; H04N 21/2387; H04N 21/81; H04N 21/4147

(52) U.S. Cl. CPC H04N 21/4316; H04N 21/4147; H04N 21/812; H04N 21/2387

(57) ABSTRACT

A system for displaying commercials while time-shifting media using PVRs is provided. The system has a first processor to detect instructions for time-shifting and to send a signal to a second processor to cause commercials to be displayed in a clearly visible manner. Upon receiving an instruction to resume playback at a regular playback speed, a second signal is sent to stop displaying the commercials and restore regular playback of the media. The commercials may also be displayed taking into account the playback speed. A method for displaying commercials while time-shifting media is also provided.

### CROSS-REFERENCE TO RELATED APPLICATION

This application claims priority to and the benefit of United States Provisional Patent Application No. 62/475,543 filed Mar. 23, 2017, the contents of which are incorporated herein by reference.

### TECHNICAL FIELD

The present invention relates to personal video recorder (PVR) systems and, more particularly, to showing commercials during fast forward using PVR systems.

### BACKGROUND OF THE INVENTION

Products have been developed that allow users to record media and watch the recorded media with flexibility. Typical products include PVRs provided by TiVo™ and Rogers.

In general, these products provide the users with the ability to fast forward, pause or rewind the recorded media, collectively called time-shifting. For example, NextBox™ is capable of at least four fast forwarding speeds. Thus, the users may be able to skip to the portion of the recorded media of interest. The users may also fast forward past the commercials.

While it is convenient for the users to be able to fast forward through the commercials, it is not good news for the advertisers. The advertisers generally pay for the time slots during the program to show their commercials to the users. If the users can fast forward past the commercials, the advertisers are not getting what they paid for. In turn, the advertisers may choose to pay less for the same time slots or display their commercials through other channels, resulting in loss of revenue for the broadcasting companies.

It would therefore be desirable to provide a system for showing commercials without affecting the flexibility PVRs provide to the users.

### BRIEF SUMMARY OF THE INVENTION

A system is provided for showing commercials when the recorded media is not shown in regular speed, for example, when the recorded media is being fast forwarded, rewound or paused. A first processor is provided to recognize that the recorded media is not shown in regular speed and a second processor is provided to show commercials during such periods and to stop showing commercials when the first processor detects that the recorded media is being shown at the regular speed.

A method for using such a system is also provided.

### BRIEF DESCRIPTION OF THE DRAWINGS

Reference will now be made, by way of example, to the accompanying drawings which show example embodiments of the present application, and in which:

FIG. 1 is a schematic view of the system of the invention.

FIG. 2 is a flowchart representing the process of the invention.

FIGS. 3A-3D illustrate some of the different manners in which the commercials are displayed.

### DESCRIPTION OF EXAMPLE EMBODIMENTS

In various examples, the present disclosure describes devices and methods showing commercials during time-shifting of the recorded media. Although the present disclosure provides examples, the disclosed methods and devices may be suitable for other purposes, with modification as appropriate.

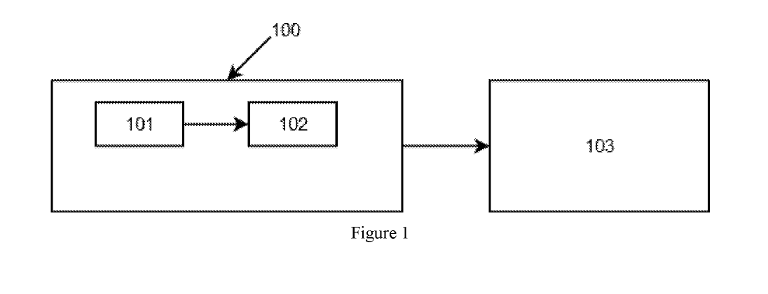

Reference is now made to FIG. 1, which shows a modified PVR 100 with a first processor 101 and a second processor 102, and the PVR 100 causes media to be displayed on a display 103, which may be a monitor or a TV. The components of the PVR 100 that are commonly known in the field are not shown.

The first processor 101 is configured to detect instructions from a user to fast forward, pause or rewind the media. Upon detecting the instruction, the first processor 101 sends a signal to the second processor 102, which then causes commercials to be displayed on the display 103.

It is appreciated that in some embodiments, the first processor 101 may be a discrete processor that is added to commonly available PVRs to detect the instructions and send a signal to the second processor 102. In some embodiments, the first processor 101 may be a processor in commonly available PVRs that is modified by hardware and/or software.

Once the second processor 102 receives the signal from the first processor 101, it causes commercials to be displayed on the display 103 and controls the manner in which the commercials are displayed.

In some embodiments, the first processor 101 may detect instructions to restore the playback speed to a regular playback speed.

In some embodiments, the first processor 101 may also detect the playback speed and send a signal that includes information about the playback speed to the second processor 102. The manner in which the commercials are displayed may take into account the playback speed of the media.

When the first processor 101 detects an instruction to restore the playback speed to the regular playback speed, it sends a signal to the second processor 102 to stop displaying the commercials and resume regular playing of the media.

It is appreciated that the second processor 102 may be the same processor as the first processor 101, wherein the first processor 101 integrates the function of causing the commercials to be displayed and controlling the manner in which the commercials are displayed. It is also appreciated that the second processor 102 may be an existing processor in commonly available PVRs that is modified by hardware and/or software.

It is also appreciated that the processors 101 and 102 may comprise a device external to the PVR. For example, the device may be intermediate between the PVR and the display and superimposes the commercials on top of the media output from the PVR.

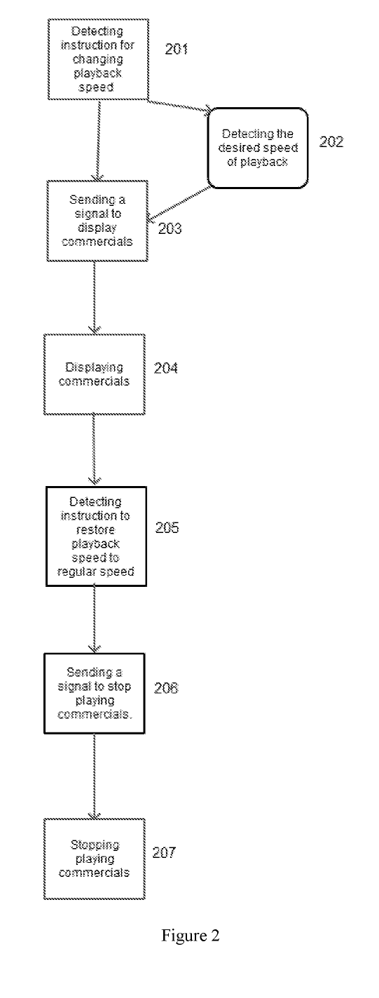

Reference is now made to FIG. 2, which shows a method for displaying commercials when the media is fast forwarded, paused or rewound.

In step 201, an instruction to change the playback speed is detected. The change of playback speed may be fast forward, pause or rewind. A signal is sent to display commercials in step 203. The commercials are then displayed on a display in step 204. Once an instruction to restore the playback speed to the regular speed is detected in step 205, a signal is sent to stop playing commercials in step 206 and the commercials are stopped from being displayed in step 207 and the media is displayed at the regular speed.

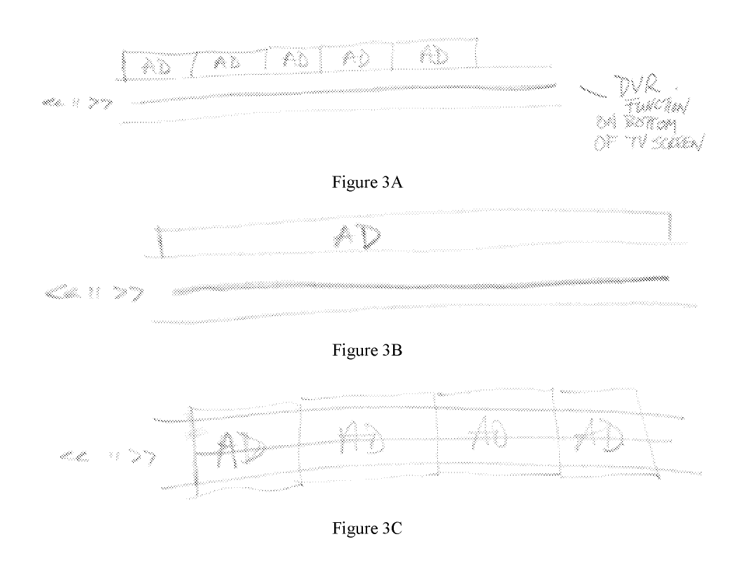

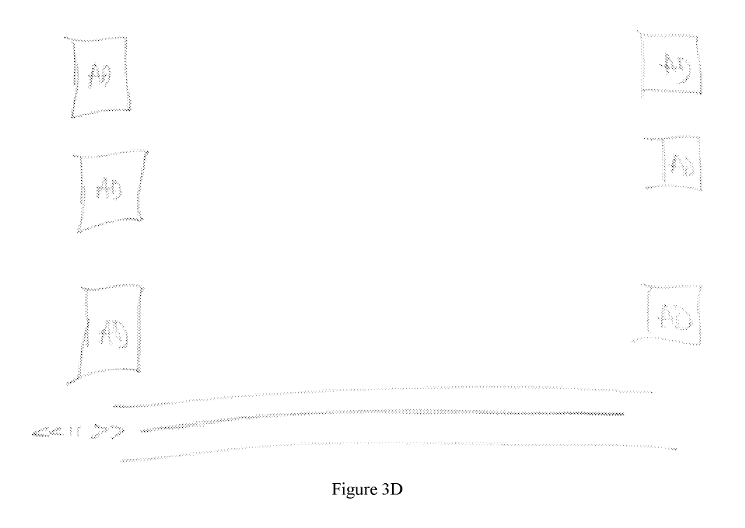

Usually when the playback speed is changed from the regular playback speed, a media playback status is shown on the display screen. The pop up commercials may be positioned offset from the media playback status so that the latter is visible. FIGS. 3A and 3B shows that the media playback status is shown close to the bottom of the display, while the pop up commercials are shown above the media playback status. It is understood that the media playback status may be shown elsewhere on the display screen and the pop up commercials are offset from the media playback status. FIG. 3C shows the pop up commercials over the media playback status. The transparency of the pop up commercials may be adjusted to allow the media playback status to be visible.

FIG. 3A shows that several pop up commercials are shown side by side at the same time. FIG. 3B shows that the pop up commercials are displayed sequentially. It is appreciated that the pop up commercials may be displayed at any desired intervals. FIG. 3C shows several pop up commercials that are shown at the same time over the media playback status. It is understood the pop up commercials may be displayed sequentially over the media playback status as well.

The pop up commercials may contain brand name and commercial messages, etc. They may be stationary or moving. The pop up commercial may represent the advertisement being time-shifted. For example, if five advertisements are being skipped, there may be five pop up commercials, each representing one of the five advertisements. The order of the pop up commercials may be changed as desired. For example, the pop up commercials may be displayed in the same order as or in an order different from the advertisements being skipped.

In some embodiments, the pop up commercials may represent some other advertisements.

In some embodiments, if the playback speed still allows the media, in particular the advertisements in the media, to be seen, the pop up commercials may be displayed without obscuring the media. For example, the pop up commercials may be displayed above the media playback status along the edges of the display, leaving the media, in particular the advertisement in the media, visible in the central portion of the display, as shown in FIG. 3D.

There may be one or more pop-up commercials displayed at the same time, as shown in FIGS. 3A-3D.

In some embodiments, there may be an additional step 202, in which the playback speed of the media is also detected and a signal is sent to display the commercials in step 203, the signal including information about the playback speed. When the commercials are displayed, the manner of display may take into account the desired speed of playback. For example, when the playback speed is faster, the number of commercials displayed in sequence may be reduced according to the shortened time it takes to skip through the media. When the media is paused, i.e, the playback speed is zero, the pop up commercials may be displayed in any desirable manner. For example, the pop up commercials may remain constant during the pause. The commercials may also be changed intermittently during pause at predetermined intervals.

The embodiments of the present disclosure described above are intended to be examples only. The present disclosure may be embodied in other specific forms. Alterations, modifications and variations to the disclosure may be made without departing from the intended scope of the present disclosure. While the system, devices and processes disclosed and shown herein may comprise a specific number of elements/components, the systems, devices and assemblies could be modified to include addition or fewer of such elements/components. For example, while any of the elements/components disclosed may be referenced as being singular, the embodiments disclosed herein could be modified to include a plurality of such elements/components. Selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

1. A system for displaying commercials on a display when time-shifting media from personal video recorder, comprising:
a first processor for detecting first instructions for changing playback speed of the media from a regular playback speed and sending a first signal upon detection of the instructions,
a second processor for receiving the signal and causing display of the commercials upon receiving the signal,
wherein the commercials are in addition to the media.

2. The system of claim 1, wherein the first processor further configured for detecting playback speed of the media.

3. The system of claim 2, wherein the signal further comprising information about the playback speed.

4. The system of claim 3, wherein the second processor takes into account the playback speed when causing the display of the commercials.

5. The system of claim 2, wherein the first processor is further configured to send a second signal to restore the playback speed of the media to the regular playback speed.

6. The system of claim 5, wherein the second processor is further configured to receive the second signal, and upon receiving the second signal, to stop displaying the commercials and to resume the media at the regular playback speed upon receiving the second signal.

7. The system of claim 1, wherein the first processor is further configured to detect instructions to change the playback speed of the media to the regular playback speed and to send a third signal to the second processor.

8. The system of claim 7, wherein the second process is further configured to receive the third signal, and upon receiving the third signal, to stop displaying the commercials and to resume the media at the regular playback speed upon receiving the second signal

9. The system of claim 1, wherein a media playback status is displayed on the display.

10. The system of claim 1, wherein the second processor further positions the commercials on the display.

11. The system of claim 10, wherein the commercials are positioned offset from the media playback status.

12. The system of claim 10, wherein the commercials are positioned over the media playback status.

13. The system of claim 12, wherein the second processor is further configured to control the transparency of the commercials.

14. The system of claim 10, wherein the commercials are positioned to show at least a portion of the media in a portion of the display.

15. The system of claim 1, wherein the first processor and the second processor are the same processor.

16. A method for displaying commercials on a display when time-shifting media from personal video recorder, comprising:
a) detecting first instructions for changing playback speed of the media from a regular playback speed;
b) sending a signal for displaying the commercials; and
c) displaying the commercials on the display.

17. The method of claim 16, further comprising:
d) detecting second instructions to restore the playback speed of the media to the regular playback speed;
e) sending a second signal to stop displaying the commercials; and
f) stopping displaying the commercials and resuming playback of the media.

18. The method of claim 16, wherein a media display status is shown when the media is time-shifted.

19. The method of claim 16, further comprising, between steps a) and b):
a1) detecting playback speed.

20. The method of claim 18, wherein the commercials are displayed taking into account the playback speed.
